(19) United States
(12) Patent Application Publication
(10) Pub. No.: US 2024/0351825 A1
(43) Pub. Date: Oct. 24, 2024

(54) METHOD AND A MONITORING ARRANGEMENT

(71) Applicant: Kone Corporation, Helsinki (FI)

(72) Inventors: Juha HELENIUS, Helsinki (FI); Henri WENLIN, Helsinki (FI); Markus KASTINEN, Helsinki (FI); Mikael PARTANEN, Helsinki (FI); Joni STENBERG, Helsinki (FI); Muhammad Fahad KHAN, Helsinki (FI); Zuhair ul HAQ, Helsinki (FI); Guy LEMSTRÖM, Helsinki (FI)

(73) Assignee: Kone Corporation, Helsinki (FI)

(21) Appl. No.: 18/631,618

(22) Filed: Apr. 10, 2024

(30) Foreign Application Priority Data
Apr. 18, 2023 (EP) 23168487.9

(51) Int. Cl. B66B 7/12; B66B 3/00; B66B 5/02; G06T 7/00; G06V 10/145; G06V 10/75

(52) U.S. Cl. CPC B66B 7/1238; B66B 3/002; B66B 5/02; G06T 7/0002; G06V 10/145; G06V 10/751

(57) ABSTRACT

The invention relates to a method of monitoring an elevator roping, the roping comprising plurality of movable ropes, the method comprising emitting light in particular with one or more light sources on the ropes while they move past the one or more light sources; and capturing with a camera system images continuously or intermittently of a zone towards which the one or more light sources emit light; and analyzing with an analyzing system the images captured by the camera system. Said emitting comprises emitting on a flank of each of said ropes at least one light beam having a shape, and said analyzing comprises recognizing in the images patterns of light emitted on said ropes and analyzing one or more characteristics of the recognized patterns. The invention also relates to a monitoring arrangement implementing the method.

### RELATED APPLICATIONS

This application claims priority to European Patent Application No. 23168487.9 filed on Apr. 18, 2023, the entire contents of which are incorporated herein by reference.

### FIELD OF THE INVENTION

The invention relates to monitoring a roping of an elevator arrangement. The elevator arrangement is an elevator arrangement suitable for transporting passengers and/or goods.

### BACKGROUND OF THE INVENTION

Elevator arrangement for transporting passengers and/or goods typically comprises a roping comprising plurality of ropes. The roping is typically connected to an elevator car and a counterweight.

Each rope typically comprises one or more load bearing members that are elongated in the longitudinal direction of the rope and each form a structure that continues unbroken throughout the length of the rope. Load bearing members are the members of the rope which are able to bear together the load exerted on the rope in its longitudinal direction. The load, such as a weight suspended by the rope, causes tension on the load bearing member in the longitudinal direction of the rope, which tension can be transmitted by the load bearing member in question all the way from one end of the rope to the other end of the rope. Ropes may further comprise non-bearing components, such as an elastic coating, which cannot transmit tension in the above described way.

The conventional elevator ropes are round in cross section. In prior art, also belt-like ropes are known. In such ropes, the load bearing members are usually embedded in a polymer coating, such as rubber or polyurethane coating, forming the surface of the hoisting rope. In the belt-shaped solutions, the load bearing members are most commonly cords made of steel wires twisted together or alternatively elongated composite members made of composite material.

For the sake of safety, it's essential that the condition of the ropes of an elevator arrangement are monitored reliably. In addition, so as to minimize elevator downtime, it's preferred that poor rope condition can be detected early so that corrective actions (ordering of replacement ropes etc.) can be taken on time. The condition monitoring may comprise monitoring condition of any of multiple components of the rope. Also, the lateral positions of the ropes can be monitored. If a rope is positioned incorrectly, this may indicate incorrect operation of the rope(s) which may be due to an internal flaw of the rope in question. Incorrect position can also be due to incorrect operation of some other components of the elevator arrangement, such as a rope wheel for instance.

The traditional method for rope condition monitoring of steel wire ropes is visual detection of wire breaks. However, this method cannot be effectively utilized with all ropes. An alternative solution has been proposed in US2014182975A1 wherein condition monitoring is performed by monitoring electrical parameters, and in particular resistance, of the fiber reinforced load bearing members.

A challenge in condition monitoring has been the difficulties in noticing rope deterioration early in advance. Most damages occur without prior warnings, which may cause severe problems. Also, some damages are difficult to notice. Such damages include particularly delamination of a composite load bearing member or some local damages which may occur already during installation. A challenge has also been that the position of damage is difficult to find, particularly with methods monitoring electrical parameters of the ropes cannot indicate the location of rope damage.

A method for condition monitoring has also been disclosed in document EP3135621B1. In this document rope lateral position data is collected. A contactless sensing has been proposed, such as a camera surveillance or light curtain has been proposed. However, even better solution would be valuable which could detect more accurately condition of the rope and detect multiple aspects of rope condition.

### BRIEF DESCRIPTION OF THE INVENTION

The object of the invention is to achieve an improved method and arrangement whereby an elevator roping can be monitored.

An object is particularly to introduce a solution where one or more aspects of an elevator roping can be monitored, such as one or more of: condition of one or more internal parts of a rope, condition of a coating of a rope, position of a rope. An object is inter alia to provide a solution by which for instance cracks, cuts or delamination of load bearing members or coating of a rope or wear of rope parts can be noticed and reacted to. An object is particularly to introduce a solution by which monitoring can be performed efficiently and continuously and/or at least in a relatively highly automatized manner.

It is brought forward a new method of monitoring an elevator roping, the roping comprising plurality of movable ropes. The method comprises
emitting light on the ropes, in particular with one or more light sources, while they move past the one or more light sources; and
capturing with a camera system images, in particular continuously or intermittently, in particular of a zone towards which the one or more light sources emit light; and
analyzing with an analyzing system the images captured by the camera system.

Said emitting comprises emitting on a flank of each of said ropes at least one light beam having a shape, and said analyzing comprises recognizing in the images patterns of light emitted on said ropes and analyzing one or more characteristics of the recognized patterns.

With this kind of solution one or more of the above-mentioned objects can be facilitated. The beam being shaped facilitates that the topography of said parts is simple to monitor based on the pattern recognized in the image. As part of the monitoring, characteristics of the pattern can be analyzed. Thus, it is possible to react if one or more characteristics of the pattern recognized are considered alarming, for instance.

Preferable further details of the method are introduced in the following, which further details can be combined with the method individually or in any combination.

In a preferred embodiment, said shape of the light beam is planar. Then, in particular in said emitting, one or more planar light beams of light is/are emitted on a flank of each said rope.

In a preferred embodiment, said beam has one or more planar sides or side portions. This is advantageous, because a planar side forms a visible and straight border of a pattern when the beam hits a continuous planar face. This is a simple shape to form and observe. It also efficiently brings visible the topography of rope parts, which facilitates monitoring the condition thereof. The planar side/side portions can be easily provided by shaping the light beam(s) planar.

In a preferred embodiment, said recognizing, and preferably also said analyzing one or more characteristics of the recognized patterns, is performed by an image recognition software, in particular running on a computer of the analyzing system. Said computer may be a local or remote computer, for instance.

In a preferred embodiment, the method comprises storing the captured images in a memory accessible by a computer of the analyzing system, which memory may be a cloud memory.

In a preferred embodiment, the analyzing comprises determining whether the one or more characteristics of the recognized patterns meet one or more predetermined criteria, and performing one or more predetermined actions if said one or more predetermined criteria are met, said one or more actions preferably comprising one or more of sending an alarm signal, sending a service call, stopping operation of the elevator, preventing car movement.

In a preferred embodiment, the analyzing comprises determining a momentary value for each of said one or more characteristics based on one or more images captured.

In a preferred embodiment, the analyzing, preferably said determining in particular, comprises comparing the one or more characteristics of the recognized patterns with one or more references. This may be done for example preferably by comparing a momentary value of each said characteristic with a predetermined reference value.

In a preferred embodiment, the analyzing, preferably said determining in particular, comprises comparing the recognized patterns with one or more references, such as with reference patterns. This is preferably performed by an image recognition software running on a computer of the analyzing system. The reference patterns, or reference images containing reference patterns, can be stored in a library of a memory of the computer for instance.

In a preferred embodiment, the method comprises identifying the individual rope or individual ropes and/or a manufacturing batch thereof and/or a manufacturing date thereof.

In a preferred embodiment, the method comprises reading by the analyzing system an identification marking of a rope such as an identification number or identification text or barcode or QR code or data matrix in one or more images captured.

It is also brought forward a new monitoring arrangement of an elevator roping, the roping comprising plurality of movable ropes, the monitoring arrangement comprising
one or more light sources arranged to emit light on the ropes; and
a camera system arranged to capture images, in particular continuously or intermittently, of a zone towards which the one or more light sources emit light; and
an analyzing system configured to analyze the images captured by the camera system.

The one or more light sources are arranged to emit on a flank of each of said ropes at least one light beam having a shape, and the analyzing system is configured to recognize in the images patterns of light emitted on said ropes and to analyze one or more characteristics of the recognized patterns of light.

With this kind of solution one or more of the above-mentioned objects can be facilitated.

Preferable further details of the arrangement and method are introduced in the following, which further details can be combined with the arrangement and method individually or in any combination.

In a preferred embodiment, said shape is planar and/or said beam has one or more planar sides or side portions. This is advantageous, because hereby the light produces a pattern with an easily recognizable border. It also efficiently brings well visible the topography of rope(s)/rope parts, which facilitates monitoring thereof. This also facilitates extending the beam across one or more complete individual ropes while also being likely to produce an easily recognizable and analyzable pattern.

In a preferred embodiment, the same beam intersects plurality of the ropes, preferably all the ropes.

In a preferred embodiment of the method and arrangement, the light is laser light.

In a preferred embodiment of the method and arrangement, the camera system comprises one or more cameras. Each camera is preferably in particular arranged to capture images continuously or intermittently of a zone towards which the one or more light sources emit light.

In a preferred embodiment of the method and arrangement, the analyzing system is configured to perform at least said recognizing, and preferably also said analyzing one or more characteristics of the recognized patterns, by an image recognition software, in particular running on a computer of the analyzing system.

In a preferred embodiment of the method and arrangement, the monitoring arrangement, in particular the camera system, is configured to store the captured images in a memory accessible by a computer of the analyzing system, which memory may be a cloud memory.

In a preferred embodiment of the method and arrangement, said characteristics include one or more of the following: the shapes of the recognized patterns in the images, the positions of the recognized patterns in the images, the positions of one or more edges of the recognized patterns in the images, the light intensities of the recognized patterns of light in the images.

In a preferred embodiment of the method and arrangement, the analyzing system is configured to determine whether the one or more characteristics of the recognized patterns meet one or more predetermined criteria, and to perform one or more predetermined actions if said one or more predetermined criteria are met, said one or more actions preferably comprising one or more of sending an alarm signal, sending a service call, stopping operation of the elevator, preventing car movement.

In a preferred embodiment of the method and arrangement, the one or more light sources and one or more cameras of the camera system are positioned beside the ropes, in particular such that the ropes are moveable past them during elevator operation.

In a preferred embodiment of the method and arrangement, the one or more light sources and the one or more cameras of the camera system are mounted on a stationary structure and arranged to be immovable during their operation i.e. the emitting and the capturing.

In a preferred embodiment of the method and arrangement, the one or more light sources is/are arranged to emit said one or more light beams continuously or intermittently.

In a preferred embodiment of the method and arrangement, each said rope comprises one or more load bearing members.

In a preferred embodiment of the method and arrangement, each said rope is a belt. That is, the width of the rope 3 is greater than its thickness in a transverse direction of the rope. The width/thickness ratio of the rope 3 is in the preferred embodiment greater than 2.

In a preferred embodiment of the method and arrangement, each said rope comprises one or more load bearing members embedded in a coating.

In a preferred embodiment of the method and arrangement, the aforementioned load bearing members are adjacent each other in width direction of the rope and isolated from each other by the aforementioned coating.

In a preferred embodiment of the method and arrangement, the aforementioned coating is transparent. In this case, the beam reaches well the internal components of the rope, and the pattern can be used in the analysis to identify if the internal components, such as in particular the individual load bearing members, of the rope have structural irregularities.

In a preferred embodiment of the method and arrangement, each said rope comprises one or more load bearing members made of composite material comprising reinforcing fibers, preferably carbon fibers, embedded in a matrix, which matrix comprises polymer material, such as epoxy for instance.

In a preferred embodiment of the method and arrangement, the one or more beams are emitted on the front side flanks of the ropes.

In a preferred embodiment of the method and arrangement, the rope is a belt, and each said front side flank is the wide flank of the rope, i.e. the flank facing in thickness direction of the rope.

In a preferred embodiment of the method and arrangement, a plate has been positioned on the back side of the ropes. The plate is preferably planar or concave. It may be reflective.

In a preferred embodiment of the method and arrangement, a plate has been positioned on the back side of the ropes and it is concave and arranged to reflect one or more beams b emitted from the front side of the row on the back side flank of the rope and to reflect a view of said back side flank to the camera system.

In a preferred embodiment of the method and arrangement, the roping comprises the ropes in a row adjacent each other in a width direction of the row.

In a preferred embodiment of the method and arrangement, the one or more light sources and one or more cameras of the camera system are positioned on the same side of the aforementioned row, preferably within the width of the rope.

In a preferred embodiment of the method and arrangement, the roping is a roping of an elevator, and connected to an elevator car. The roping is preferably a suspension roping arranged to suspend the car or alternatively a compensation roping.

In a preferred embodiment, monitoring arrangement, such as the analyzing system thereof for instance, is configured to identify, the individual rope or individual ropes and/or a manufacturing batch thereof and/or a manufacturing date thereof. For this purpose, the monitoring arrangement, such as the analyzing system thereof for instance, is preferably configured to read an identification marking of a rope such as an identification number or identification text or barcode or QR code or data matrix in one or more images captured.

In a preferred embodiment, the elevator arrangement is an elevator arrangement for transporting passengers and/or goods.

### BRIEF DESCRIPTION OF THE DRAWINGS

In the following, the present invention will be described in more detail by way of example and with reference to the attached drawings, in which

FIG. 1 illustrates schematically a side view of a monitoring arrangement of an elevator roping according to a first embodiment implementing a method of monitoring an elevator roping according to an embodiment.

FIG. 2 illustrates a front view of the roping of FIG. 1.

FIG. 3 illustrates an example of an actual image captured by the camera system of FIG. 1.

FIG. 4 illustrates a view in longitudinal direction of the arrangement of FIG. 1 (analyzing system not shown).

FIG. 5 illustrates preferred details of the camera system and the analyzing system.

FIG. 6 illustrates preferred details of a rope as viewed from a front side.

FIG. 7 illustrates a cross section of the rope of FIG. 6.

FIG. 8 illustrates preferred details of the elevator arrangement.

FIG. 9 illustrates details of a monitoring arrangement according to a second embodiment.

FIG. 10 illustrates details of a monitoring arrangement according to a third embodiment.

FIG. 11 illustrates details of a monitoring arrangement according to a fourth embodiment.

### DETAILED DESCRIPTION

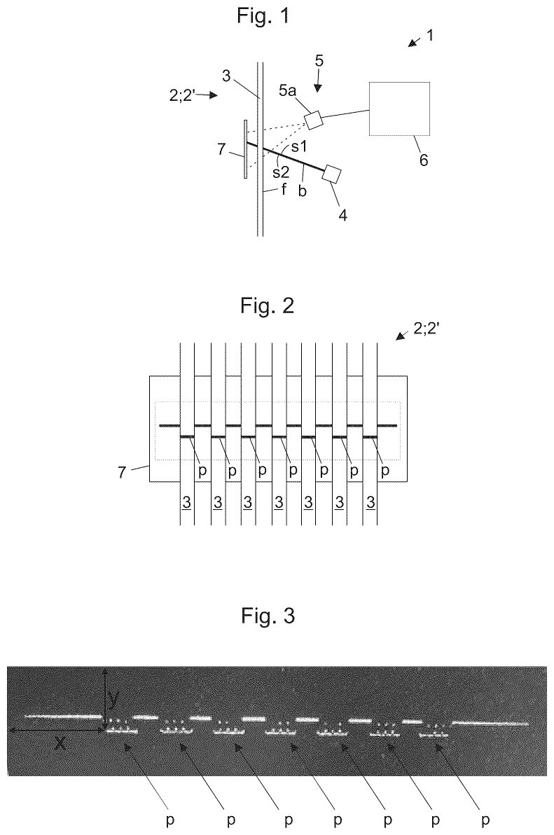

FIG. 1 illustrates a monitoring arrangement 1 of an elevator roping 2;2′ according to an embodiment. The arrangement 1 implements a method of monitoring an elevator roping 2;2′ according to an embodiment.

The embodiment of the monitoring arrangement 1 illustrated in FIG. 1 comprises a roping 2;2′ comprising plurality of movable ropes 3. The roping 2;2′ is preferably a roping connected to an elevator car 8. The monitoring arrangement 1 further comprises a light source 4 arranged to emit light on the ropes 3. The light source 4 is positioned beside the ropes 3, in particular such that the ropes are moveable past the light source 4. The monitoring arrangement 1 further comprises a camera system 5 arranged to capture images, in particular continuously or intermittently, of a zone towards which the light source 4 emits light; and an analyzing system 6 configured to analyze the images captured by the camera system 5. The light source 4 is arranged to emit on a flank f of each of said ropes 3 a light beam b having a shape, and the analyzing system 6 is configured to recognize in the images patterns p of light emitted on said ropes 3 and to analyze one or more characteristics of the recognized patterns p of light.

The camera system 5 comprises a camera 5a, which is arranged to capture images, preferably continuously or intermittently, of a zone towards which the light source 4 emits light.

In the embodiment of the method illustrated in FIG. 1 light is emitted with the light source 4 on the ropes 3 while they move past the light source 4. The method comprises capturing with the camera system 5 images, in particular continuously or intermittently, of a zone towards which the light source 4 emits light. The method comprises analyzing with an analyzing system 6 the images captured by the camera system 5. Said emitting comprises emitting on a flank f of each of said ropes 3 a light beam b having a shape. Said analyzing comprises recognizing in the images patterns p of light emitted on said ropes 3 and analyzing one or more characteristics of the recognized patterns p.

FIG. 2 illustrates the roping 2;2′ as viewed from viewpoint of the camera system 5 showing schematically patterns p of light emitted on said ropes 3. FIG. 3 illustrates an example of an actual image captured by the camera system 5, showing patterns p of light emitted on said ropes 3.

The beam b reflects from the parts of the rope 3 that are not fully transparent. The beam shape being known facilitates that the topography of said parts is simple to monitor based on the reflection of the beam b, which reflection is recognizable as a pattern p in the image. Characteristics of the pattern p can then be analyzed. Thus, it is possible to react if one or more characteristics of the pattern p recognized differ from reference characteristics.

In the preferred embodiment of the arrangement and method illustrated in FIG. 1, said shape of the beam b is planar. Thus, in said emitting, a planar light beam b is emitted on a flank f of each said rope 3. Said beam b has opposite two planar sides s1,s2 as illustrated in FIG. 1. This is advantageous, because each planar side forms a visible a straight border of a pattern when the beam b hits a continuous planar face. This is a simple shape to form and observe. It also efficiently brings visible the topography of rope parts, which facilitates monitoring thereof. Irregularities, for example discontinuities, of the shape of rope parts (intended or unintended) are easily detectable. An irregularity can also easily and logically be associated with certain kind of intended structure or unintended defect, which makes analysis of the pattern p relatively simple. Particularly, it makes it relatively simple to determine and give the analyzing system the limits which should trigger an alarm or some other predetermined action.

The analyzing the one or more characteristics of the recognized patterns p preferably comprises determining a momentary value for each of said one or more characteristics based on one or more images captured.

Said characteristics preferably include one or more of the following:
shapes of the recognized patterns p in the images;
dimensions of shapes of the recognized patterns p in the images, such as width and/or height;
positions p of the recognized patterns p in the images;
positions p of one or more edges of the recognized patterns p in the images;
light intensities within the recognized patterns p of light in the images, such as areas or lines having low (e.g. below a limit value) light intensity within the recognized patterns p of light in the images.

The analyzing the one or more characteristics of the recognized patterns comprises determining whether the one or more characteristics of the recognized patterns p meet one or more predetermined criteria, and performing one or more predetermined actions if said one or more predetermined criteria are met. In the arrangement 1, this is implemented such that the analyzing system 6 is configured to determine whether the one or more characteristics of the recognized patterns p meet one or more predetermined criteria, and to perform one or more predetermined actions if said one or more predetermined criteria are met. Said one or more actions preferably comprising one or more of sending an alarm signal, sending a service call, stopping transport operation of the elevator arrangement, preventing car movement.

In the preferred embodiment, the analyzing, in particular the aforementioned step of determining whether the one or more characteristics of the recognized patterns p meet one or more predetermined criteria, comprises comparing the one or more characteristics of the recognized patterns p with one or more references. This is preferably performed by comparing the aforementioned momentary value of the characteristic in question with a predetermined reference value.

The comparison can be implemented such that, for example, a momentary value of a dimension (such as width and/or height) or a position of a shape of a recognized pattern is first determined by measuring and thereafter the determined momentary value is compared with a predetermined reference value. For example, position, width and/or height of a shape of the pattern p in an image can be measured e.g. by the image recognition software. The determining of a position is preferably implemented by measuring positions of one or more edges of the recognized patterns p in the images. In FIG. 3, rope position is indicated by x and y.

Generally, when any of the characteristics listed, such as a dimension and/or position, shape or light intensity differs from a reference, this can be simply used as an indicator of an alarming condition to be checked.

In the preferred embodiment, the beam b intersects all the ropes 3. This simplifies the arrangement 1. However, this is not necessary, because alternatively multiple beams could be emitted. For example, different ropes could be lighted by different beams, e.g. one beam per each rope.

The light is preferably laser light. Thus, the beam b can be made to have accurate shape with sharp borders and consistent reflection behaviour. Thereby, the patterns p in the images will relatively reliably and accurately indicate the topography of the rope parts. Alternatively, the light could be of some other kind.

In the preferred embodiment of the method and arrangement 1, said recognizing is preferably performed/configured to be performed by an image recognition software, in particular running on a computer 6b of the analyzing system 6. This is illustrated in FIG. 5. Preferably then, the method comprises storing the captured images in a memory 6a accessible by the computer 6c of the analyzing system 6. Said computer 6b may be a local or remote computer, as illustrated in FIG. 5. The memory 6a is preferably, although not necessarily, a cloud memory. The computer 6b could alternatively be a part of an elevator control system, for instance.

In the preferred embodiment, each said rope 3 is a belt. That is, the width of the rope 3 is greater than its thickness in a transverse direction of the rope. The width/thickness ratio of the rope 3 is in the preferred embodiment greater than 2. In such a case, great proportion of the structure of the rope 3 can be efficiently monitored from the width directional side, i.e. by recognizing in images patterns produced by the beam on the wide flank f of the rope 3.

FIGS. 6 and 7 illustrate preferred structure of the rope 3. In this case, the belt 3 comprises plurality of load bearing members 3a adjacent each other in width direction of the belt 3. Each load bearing member 3a is an elongated member extending parallel with the longitudinal direction of the belt 3 as a structure that continues unbroken throughout the length of the rope 3.

The load bearing members 3a are embedded in a coating 3b. The load bearing members 3a are adjacent each other in width direction of the rope 3 and isolated from each other by the coating 3b. The coating is preferably made of material comprising polymer, such as of rubber or polyurethane or silicone. The coating 3b is preferably transparent. In this case, the beam b reaches well the internal components of the rope 3, and the pattern p can be used in the analysis to identify if the internal components, such as in particular the individual load bearing members 3a, of the rope 3 have structural irregularities.

In the preferred embodiment, the load bearing members 3a are made of composite material comprising reinforcing fibers, preferably carbon fibers, embedded in a matrix, which matrix comprises polymer material, such as epoxy for instance. This kind of composite material structure needs to be monitored, however it is relatively difficult to be done continuously. Therefore, when the load bearing members of a rope 3 are of composite material it is particularly advantageous to monitor condition of the rope 3 by analyzing the characteristics of the patterns p.

In the preferred embodiment of FIG. 1, the beam b is emitted on the front side flanks f of the ropes 3. In the preferred embodiment, the rope 3 is a belt, and each said front side flank f is the wide flank of the rope 3, i.e. the flank facing in thickness direction of the rope 3. As illustrated in FIG. 1, a plate 7 has been positioned on the back side of the ropes 3. There can be more than one of said plates 7. The plate 7 can have various alternative purposes. Firstly, it blocks the beam b from proceeding to surroundings, for instance. Secondly, the part of the beam b not being reflected or absorbed by the ropes 3, can be reach the plate 7 and form second patterns on the plate 7. Also these second patterns can be recognized in the images and analyzed, correspondingly as the patterns p. This can be used to obtain additional information of the rope structure 3. Thirdly, the plate 7 can be made reflective (e.g. a mirror), and arranged to reflect the beam b on the back side flank of the rope 3, as well as to reflect view of said back side flank to the camera system 5.

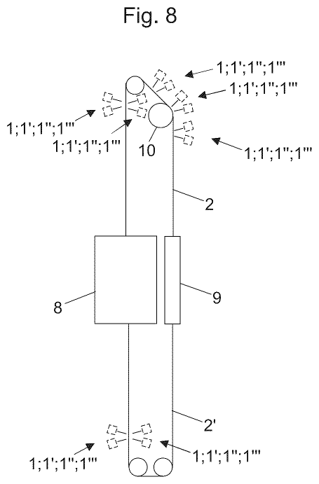

FIG. 8 illustrates preferred features of an elevator arrangement comprising the roping 2;2′ being monitored. The elevator arrangement comprises an elevator car 8 and a counterweight 9 interconnected by a hoisting roping 2 movable by a drive member 10, in particular a drive wheel, rotated by a motor (not shown). The elevator arrangement illustrated also comprises a compensation roping 2′. The roping 2 and/or the roping 2′ can be monitored by the method and/or monitoring arrangement as described anywhere in this application. FIG. 8 also illustrates alternative positions for the monitoring arrangement 1. The roping(s) can be simultaneously monitored from plurality of said positions.

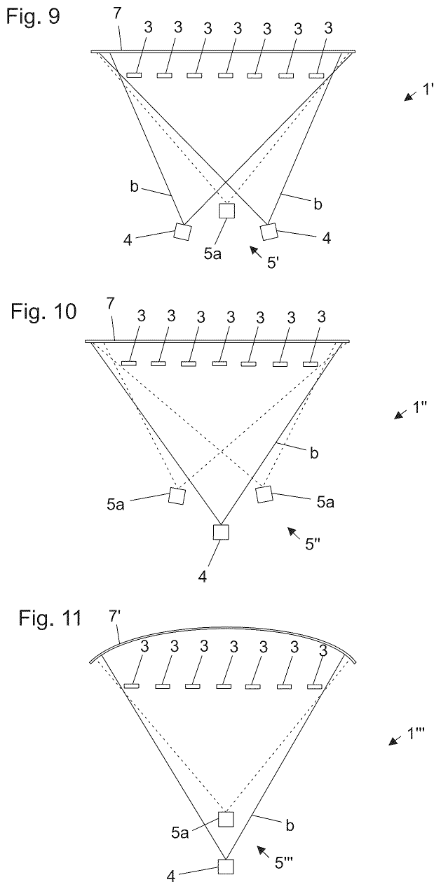

FIG. 9 illustrates a monitoring arrangement 1′ of an elevator roping 2;2′ according to a second embodiment, which arrangement 1′ implements the earlier described method for monitoring an elevator roping 2;2′ according to an embodiment (analyzing system 6 not shown). This embodiment is different only in that there are plurality, in particular two, of the light sources 4 emitting light on the ropes 3 while they move past the light sources 4.

FIG. 10 illustrates a monitoring arrangement 1″ of an elevator roping 2;2′ according to a third embodiment, which arrangement 1″ implements the earlier described method of monitoring an elevator roping 2;2′ according to an embodiment (analyzing system 6 not shown). This embodiment is different only in that there are plurality, in particular two, of cameras 5a comprised in the camera system 5′.

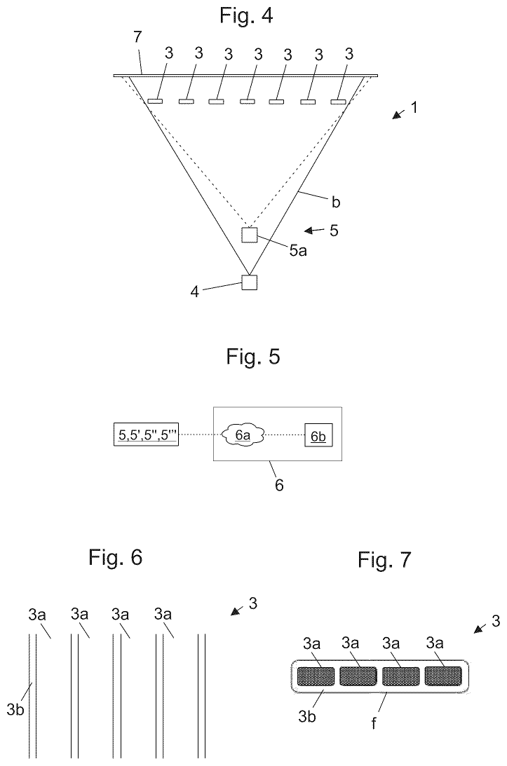

FIG. 11 illustrates a monitoring arrangement 1″ of an elevator roping 2;2′ according to a fourth embodiment, which arrangement 1″ implements the earlier described method for monitoring an elevator roping 2;2′ according to an embodiment (analyzing system 6 not shown). This embodiment is different from that presented in FIG. 4 only in that the plate 7′ positioned on the back side of the ropes 3 is concave and arranged to reflect a beam b emitted from the front side of the row on the back side flanks of the ropes 3 as well as to reflect view of said back side flank to the camera system 5″. Thus, the arrangement 1″ can monitor the ropes 3 from both sides with small amount of components.

In general, the rope 3 can have as structure as disclosed more specifically in document WO2009090299 A1.

In general, the rope 3, when being a belt, can be flat sided, or have a polyvee structure or some other surface contour such as teeth for instance.

In general, at least some of the advantages are achieved also when the rope is not belt-shaped. Namely, the rope 3 can alternatively have a round cross section.

In general, it is preferred that the one or more cameras 5a of the camera system 5 are mounted on a stationary structure and arranged to be immovable during their operation i.e. the emitting and the capturing.

In general, it is preferred that the one or more light sources 4 is/are arranged to emit said one or more light beams b continuously or intermittently (e.g. in the form of strobes or flashes).

In general, the one or more light sources 4 and one or more cameras 5a of the camera system 5 are positioned beside the ropes 3, in particular such that the ropes 3 are moveable past them during operation of the elevator arrangement. The one or more light sources 4 and one or more cameras 5a of the camera system 5 are then positioned in close proximity of the ropes 3, preferably in particular such that the path of the beam b from each light source 4 to a rope 3 is less than 1 meters, and the path of the reflection of the beam b from said rope 3 to a camera 5a of the camera system is also less than 1 meters.

In general, the roping 2;2′ preferably comprises the ropes 3 in a row adjacent each other in a width direction of the row, as illustrated in the Figures. In general, the one or more light sources 4 and one or more cameras 5a of the camera system 5 are preferably positioned on the same side of the row (front side in Figures), preferably within the width of the row (as seen viewed in orthogonal direction to the width direction of the row), whereby the angle in which they can light/view the wide side of the row need not be very far from orthogonal.

In general, the camera system 5 and/or the analyzing system 6 can be made to be part of an elevator control system of the elevator arrangement.

In general, the method (and arrangement 1,1′,1″,1′″) can additionally, although not necessarily, further comprise identifying (or be configured therefor respectively) the individual rope(s) and/or a manufacturing batch thereof and/or a manufacturing date thereof. Then, each rope 3 of the roping 2;2′ is preferably provided with an identification means, such as an identification tag or identification marking. The identification marking may be an identification number or identification text or barcode or QR code or data matrix printed on the rope, for example or any other suitable readable identification containing identification information. The identifying can be performed by aid of the camera system 5 or alternatively with a separate camera system. The identifying preferably comprises reading by the analyzing system 6 an identification marking of a rope 3 such as an identification number or identification text or barcode or QR code or data matrix in one or more images captured. The identifying facilitates associating the results of the analysis with the rope identification data and taking individual aspects of the individual ropes, such as the history thereof for example, into account in the monitoring and in the actions to be triggered. Likewise, other additional, but optional, aspects could be monitored in the method or arrangement 1,1′,1″,1′″ by aid of the camera system 5 or alternatively with a separate camera system. Such optional aspects include for instance dirt on the rope(s), dirt or rust or oil on a rope wheel, vibration of rope(s), lateral position of rope(s). The optional aspects include also measuring colors of the coating 3b of the ropes. As the rope becomes older, the coating turns gradually from colorless to yellow. By monitoring the colors, aging of the coating 3b can be monitored.

Generally, the image recognition software running on a computer 6b of the analyzing system 6 can utilize machine learning and/or sophisticated algorithms for the recognizing in the images patterns p of light emitted on said ropes 3 and for the analyzing one or more characteristics of the recognized patterns p. In this case, the analyzing one or more characteristics of the recognized patterns p may comprise comparing by the software the recognized patterns p with references, such as with reference patterns. The reference patterns, or reference images containing reference patterns, can be stored in a library of a memory of the computer 6b for instance. The library can then include a large amount of reference patterns, or reference images containing reference patterns, each having a characteristic to be searched from the captured images by the software. These characteristics to be searched are preferably characteristics that are considered alarming, such as characteristics present when the rope(s) have defects, such as cracks, cuts or when the rope(s) or part(s) thereof have an unintended position.

Generally, to localize rope defects, the method preferably comprises storing a position data associated with the images captured and/or with images captured where the recognized patterns (p) do not meet one or more predetermined criteria. Thus, locating of an alarming part of the rope 3 can be facilitated in later inspection by a service person for instance. The position data can comprise car, for instance, when the defect is at the camera location.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A method of monitoring an elevator roping, the roping comprising plurality of movable ropes, the method comprising
emitting light, in particular with one or more light sources on the ropes while they move past the one or more light sources; and
capturing with a camera system images, in particular of a zone towards which the one or more light sources emit light; and
analyzing with an analyzing system the images captured by the camera system,
wherein said emitting comprises emitting on a flank of each of said ropes at least one light beam having a shape, and said analyzing comprises recognizing in the images patterns of light emitted on said ropes and analyzing one or more characteristics of the recognized patterns.

2. A method as defined in claim 1, wherein said shape is planar.

3. A method as defined in claim 1, wherein said beam has one or more planar sides or side portions.

4. A method as defined in claim 1, wherein said recognizing is performed by an image recognition software, in particular running on a computer of the analyzing system.

5. A method as defined in claim 1, wherein the analyzing one or more characteristics of the recognized patterns comprises determining whether the one or more characteristics of the recognized patterns meet one or more predetermined criteria, and the method comprises performing one or more predetermined actions if said one or more predetermined criteria are met, said one or more actions preferably comprising one or more of sending an alarm signal, sending a service call, stopping transport operation of the elevator arrangement, preventing car movement.

6. A method as defined in claim 1, wherein the analyzing one or more characteristics of the recognized patterns, preferably said determining in particular, comprises comparing the one or more characteristics of the recognized patterns with one or more references.

7. A method as defined in claim 1, wherein the method comprises identifying the individual rope or individual ropes and/or a manufacturing batch thereof and/or a manufacturing date thereof.

8. A method as defined in claim 1, wherein the method comprises reading by the analyzing system an identification marking of a rope such as an identification number or identification text or barcode or QR code or data matrix in one or more images captured.

9. A monitoring arrangement of an elevator roping, the roping comprising plurality of movable ropes, the monitoring arrangement comprising
one or more light sources arranged to emit light on the ropes; and
a camera system arranged to capture images of a zone towards which the one or more light sources emit light; and
an analyzing system configured to analyze the images captured by the camera system,
wherein the one or more light sources are arranged to emit on a flank of each of said ropes at least one light beam having a shape, and the analyzing system is configured to recognize in the images patterns of light emitted on said ropes and to analyze one or more characteristics of the recognized patterns of light.

10. A monitoring arrangement as defined in claim 9, wherein said shape is planar and/or said beam has one or more planar sides or side portions.

11. A method as defined in claim 1, wherein the light is laser light.

12. A method as defined in claim 1, wherein the camera system comprises one or more cameras.

13. A monitoring arrangement as defined in claim 9, wherein the analyzing system is configured to perform said recognizing by an image recognition software, in particular running on a computer of the analyzing system.

14. A method as defined in claim 1, wherein said characteristics include one or more of the following: the shapes of the recognized patterns in the images, the positions of the recognized patterns in the images, the positions of one or more edges of the recognized patterns in the images, the light intensities of the recognized patterns of light in the images.

15. A method as defined in claim 1, wherein the analyzing system is configured to determine whether the one or more characteristics of the recognized patterns meet one or more predetermined criteria, and to perform one or more predetermined actions if said one or more predetermined criteria are met, said one or more actions preferably comprising one or more of sending an alarm signal, sending a service call, stopping transport operation of the elevator arrangement, preventing car movement or the elevator in question.

16. A method as defined in claim 1, wherein each said rope comprises one or more load bearing members embedded in a coating, each said rope preferably being a belt, the coating preferably being transparent.

17. A method as defined in claim 1, wherein each said rope comprises one or more load bearing members made of composite material comprising reinforcing fibers, preferably carbon fibers, embedded in a matrix, which matrix comprises polymer material, such as epoxy for instance.

18. A monitoring arrangement as defined in claim 9, wherein the light is laser light.

19. A monitoring arrangement as defined in claim 9, wherein the camera system comprises one or more cameras.
